(19) United States
(12) Patent Application Publication
(10) Pub. No.: US 2019/0163407 A1
(43) Pub. Date: May 30, 2019

(54) STORAGE DEVICE AND STORAGE SYSTEM

(71) Applicant: RENESAS ELECTRONICS CORPORATION, Tokyo (JP)

(72) Inventor: Nobuhiro Kadoi, Tokyo (JP)

(21) Appl. No.: 16/130,890

(22) Filed: Sep. 13, 2018

(30) Foreign Application Priority Data
Nov. 28, 2017 (JP) 2017-228181

(51) Int. Cl. G06F 3/06; G06F 13/16

(52) U.S. Cl. CPC G06F 3/0673; G06F 3/061; G06F 2213/0032; G06F 3/0659; G06F 13/1689

(57) ABSTRACT

There is to provide a storage device capable of performing coupling processing normally, independently of a host device. The storage device includes a timing control unit and a coupling processing unit. The coupling processing unit performs the coupling processing with the host device according to the coupling sequence. The timing control unit controls the execution time of the coupling sequence. The timing control unit controls the coupling processing unit to transmit a control signal for performing the coupling processing with the host device, to the host device, after elapse of a predetermined set time from the timing capable of transmitting the control signal to the host device in the coupling sequence.

### CROSS-REFERENCE TO RELATED APPLICATIONS

The disclosure of Japanese Patent Application No. 2017-228181 filed on Nov. 28, 2017 including the specification, drawings and abstract is incorporated herein by reference in its entirety.

### BACKGROUND

The invention relates to a storage device and a storage system and particularly, to a storage device and a storage system having a storage device capable of coupling to a host device.

A storage device as a drive device is not used by itself but used coupled to a host device (host). The storage device includes, for example, an optical disk recording and reproducing device and a hard disk device, and the like. The host device includes, for example, a Personal Computer (PC), a recorder, a player, and the like.

An interface (I/F) is used to transmit the data read from a disk, from the storage device to the host device or receive the date written into a disk in the storage device from the host device. As one of the interface standard, there is, for example, Serial Advanced Technology Attachment; serial ATA (SATA).

Related to this technology, Japanese Unexamined Patent Application Publication No. 2012-133513 discloses a storage device that performs the processing requested by the request data, in response to request data transmitted from a host device. The storage device according to Japanese Unexamined Patent Application Publication No. 2012-133513 includes a storage, a processor, and an alternative processing unit. The processor performs first processing including a control of the storage and second processing of transmitting response data responsible to request data to the host device, according to the request data transmitted from the host device. The alternative processing unit performs the second processing on predetermined request data, of the request data transmitted from the host device, instead of the processor.

### SUMMARY

In coupling a storage device to a host device, the storage device executes predetermined sequence for physically coupling defined in the SATA standard, in reply to a request for the physical coupling from the host device. After the execution of this sequence, the storage device transmits the information indicating that the operation thereof is ready. Upon recognition of the received information, the host device determines that the storage device is controllable. The SATA standard, however, does not define the timing of transmitting the above operation ready information, after the execution of the physical coupling sequence. Timing of properly receiving the information from a storage device is various in every host device. Accordingly, there is a fear of failing in correct coupling processing in every host device.

Other objects and novel characteristics will be apparent from the description of the specification and the attached drawings.

According to one embodiment, the storage device includes a coupling processing unit that performs coupling processing with a host device according to a predetermined coupling sequence, and a timing control unit that controls the coupling processing unit to transmit a first control signal for performing the coupling processing with the host device, to the host device, after elapse of a predetermined set time from the timing capable of transmitting the first control signal to the host device in the coupling sequence.

Substitution of a method or a system for the device according to one embodiment, a program to execute the processing of the device or a part of the device in a computer, an image pickup device having the same device, and the like may be effective as one aspect of the invention.

According to the embodiment, the coupling processing can be performed normally, independently of the host device.

### BRIEF DESCRIPTION OF THE DRAWINGS

FIG. 1 is a view showing the outline of a storage system according to the embodiments.

FIG. 2 is a view showing OOB sequence.

FIG. 3 is a block diagram of a storage system according to a first embodiment.

FIG. 4 is a view showing the structure of a timer control circuit according to the first embodiment.

FIG. 5 is a view showing the structure of a signal monitoring circuit according to the first embodiment.

FIG. 6 is a flow chart showing the processing in the starting sequence of the storage device according to the first embodiment.

FIG. 7 is a flowchart showing the processing of an OOB sequence determination circuit according to the first embodiment.

FIG. 8 is a flow chart showing the processing of a starting sequence control circuit according to the first embodiment.

FIG. 9 is a block diagram showing a storage system according to a second embodiment.

FIG. 10 is a view showing the structure of a PHYRDY loss determination circuit according to the second embodiment.

FIG. 11 is a flow chart showing the processing in the starting sequence of the storage device according to the second embodiment.

### DETAILED DESCRIPTION

Hereinafter, one embodiment will be described with reference to the drawings. For the sake of clear description, the following description and drawings are properly omitted and simplified. In each drawing, the same reference numerals are attached to the same elements and the overlapping description is omitted depending on necessity.

In the following description, the subject matter will be divided into a plurality of sections or embodiments if necessary for the sake of convenience; however, they are not unrelated to each other unless otherwise specified, but are in such a relation that one represents a modification example, the application example, the details, the supplementary explanation, or the like of a part or all of the other. Further, in the following embodiments, if reference is made to any number of elements or the like (including the number of units, numeric value, quantity, range, and the like), the invention is not to be restricted to that value but the number may be more or less than the value unless otherwise explicitly specified and apparently limited to a specific value in principle.

Further, in the following embodiments, the components (including the operational steps) are not necessarily essential unless otherwise specifically stated and apparently considered to be essential in principle. Similarly, in the following embodiments, if reference is made to a shape, a positional relationship, or the like of any component or the like, those substantially approximate or similar to that shape or the like are to be included unless otherwise explicitly specified and apparently considered to be different in principle. This is the same with the above-mentioned number (the number of units, numeric value, quantity, range, and the like).

Each element described in the drawings as a function block of performing various processing can be formed by a Central Processing Unit (CPU), a memory, and the other circuit in a hardware manner, and can be realized by a program loaded in a memory in a software manner. Accordingly, those skilled in the art would understand well that these function blocks can be realized in various forms only by the hardware or the software, or their combination, and they are not to be restricted to some of them.

For the sake of clear description, the following description and drawings are properly omitted and simplified. Each element described in the drawings as a function block of performing various processing can be formed by a Central Processing Unit (CPU), a memory, and the other circuit in a hardware manner, and can be realized by a program loaded in a memory in a software manner. Accordingly, those skilled in the art would understand well that these function blocks can be realized in various forms only by the hardware or the software, or their combination, and they are not to be restricted to some of them. In the drawings, the same reference numerals are attached to the same elements and their overlapping description is omitted depending on necessity.

### Outline of Embodiments

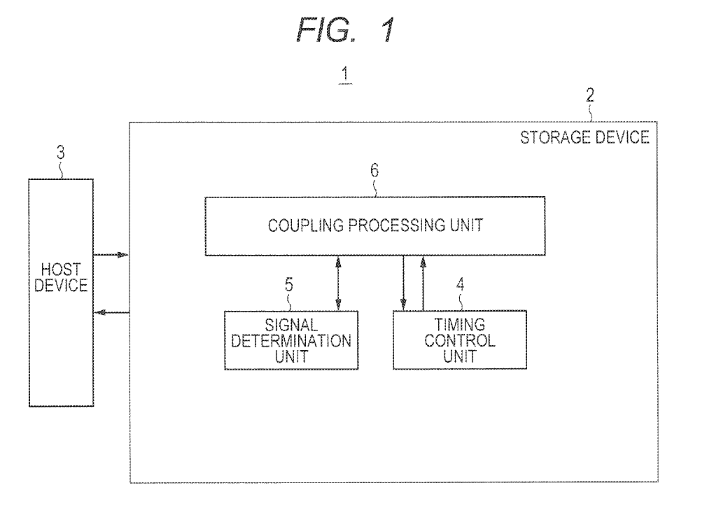

Prior to the description of the embodiments, the outline of the embodiments will be described. FIG. 1 is a view showing the outline of a storage system 1, according to the embodiments. The storage system 1 includes a storage device 2 as a device and a host device 3 as a host. The storage device 2 and the host device 3 are mutually coupled to each other, for example, by an interface of the SATA standard.

The storage device 2 is a drive device having a storage. The storage is, for example, an optical disk, a hard disk, a memory, or the like. In short, the storage device 2 is, for example, an optical disk drive (ODD; Optical Disk Drive), a hard disk drive (HDD; Hard Disk Drive), a solid state drive (SSD; Solid State Drive), or the like.

The host device 3 is, for example, a PC, a recorder, a player, or a game device. The host device 3 is a device that transmits a control signal requesting some processing to the storage device 2 and obtains the execution result of the storage device 2. The host device 3 performs the coupling processing with the storage device 2, according to the coupling sequence conforming to the SATA standard.

The storage device 2 performs the coupling processing with the host device 3, according to the coupling sequence conforming to the SATA standard. The storage device 2 executes the coupling processing and the like requested by a control signal, in reply to the control signal (request data) transmitted from the host device 3. The control signal includes, for example, an Out Of Band (OOB) signal, an Align and Frame Information Structure (FIS) signal, and the like. The OOB signal is, for example, COMRESET, COMINIT, COMWAKE, and the like. The FIS requesting some processing is, for example, FIS indicating ATA/ATAPI command. The storage device 2 performs the processing defined by the SATA standard such as reset of the storage device 2, reading and writing of the storage, and the like, in reply to the request from the host device 3.

The storage device 2 includes a timing control unit 4, a signal determination unit 5, and a coupling processing unit 6. The coupling processing unit 6 performs the coupling processing with the host device 3, according to the coupling sequence. The timing control unit 4 controls the execution time of the coupling sequence. The timing control unit 4 controls the coupling processing unit 6 to transmit a first control signal to the host device 3, after elapse of a predetermined time from the timing capable of transmitting the control signal (first control signal) for performing the coupling processing with the host device 3 to the host device 3 in the coupling sequence. The signal determination unit 5 determines the accuracy of the control signal (second control signal) received from the host device 3. When the signal determination unit 5 determines that the accuracy of the second control signal is favorable, the timing control unit 4 controls the coupling processing unit 6 to transmit the first control signal to the host device 3, after elapse of the predetermined time.

Here, in the SATA standard, a control to transfer data by three layers is performed. As the three layers, a transport layer, a link layer, and a physical layer (PHY Layer) are defined. The transport layer performs generation of FIS and control of the sequence (protocol). The link layer performs arbitration of transmission path, flow control, and conversion of the FIS and control code into bit string (8b/10b conversion). The physical layer converts bit string into serial and transfers the same. In short, actual communication is performed in the physical layer.

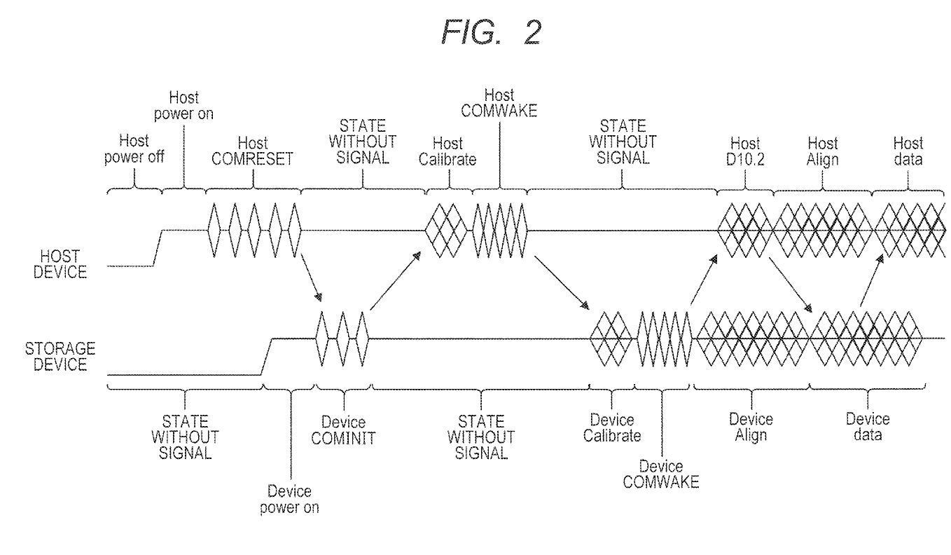

The operation between the storage device 2 and the host device 3 will be described. At first, the coupling sequence performed in the physical layer will be described. FIG. 2 is a view showing the procedure of OOB sequence. At first, the host device 3 transmits a “Host COMRESET” signal. Upon receipt of the “Host COMRESET”, the storage device 2 transmits a “Device COMINIT” signal to the host device 3. Upon receipt of the “Device COMINIT” signal, the host device 3 transmits the “Host COMWAKE” signal to the storage device 2. Upon receipt of the “Host COMWAKE” signal, the storage device 2 outputs a “Device COMWAKE” signal to the host device 3. Then, the host device 3 is synchronized with the storage device 2 during Align period, to start the data transfer.

The OOB sequence is separated into a “burst section” with signal and a “squelch section” without signal. The OOB signal is detected by detecting the “burst section” and the “squelch section”. In this OOB sequence, one of the host device 3 and the storage device 2 transmits a specified pattern (OOB pattern) corresponding to the OOB signal, to the other. The other recognizes the transmitted OOB pattern and performs the processing of specifying the OOB signal.

Next, the operation performed in the transport layer will be described. The operation of the storage device 2 is controlled according to the type of the FIS managed in the transport layer. Whether the FIS is being transmitted or being received is controlled by a control code called Primitive in the link layer. Specifically, the transmitting and receiving example of the FIS between the storage device 2 and the host device 3 will be described. The case of transmitting the FIS from the host device 3 to the storage device 2 will be described.

Before the transfer of the FIS, SYNC Primitive is transmitted and received between the host device 3 and the storage device 2. The SYNC Primitive is the primitive indicating that a bus is in idle state. When transmitting the FIS, the host device 3 transmits X_RDY Primitive as a transmission request of the FIS to the storage device 2. When receiving the X_RDY Primitive from the host device 3, the storage device 2 transmits R_RDY Primitive for notifying permission to receive the FIS, to the host device 3. According to this, the storage device 2 is in a position to receive the data, and the host device 3 starts transmitting the FIS to the storage device 2.

When receiving the FIS from the host device 3 normally, the storage device 2 transmits R_IP Primitive to the host device 3. According to this, the transmission of the FIS is completed, and the host device 3 transmits WTRM Primitive for notifying the transmission completion of the FIS to the storage device 2. When receiving the WTRM Primitive from the host device 3, the storage device 2 transmits R_OK Primitive for notifying the reception completion, to the host device 3. Thereafter, the SYNC Primitive is transmitted and received again between the host device 3 and the storage device 2. The host device 3 and the storage device 2 are in a wait state of transmission and reception of the next FIS.

As mentioned above, although the case of transmitting the FIS from the host device 3 to the storage device 2 has been described, when the transmission direction of the FIS changes, the above-mentioned respective primitives are transmitted in a reverse direction accordingly.

Generally, the storage device 2 transmits the information indicating the requested data and the contents of ATA Task Register (hereinafter, referred to as “ATA Task Register information”) to the host device 3, in reply to a request to reset and issue ATA/ATAPI command from the host device 3. The above request from the host device 3 is performed based on the specification defined by the SATA standard. In this specification, the host device 3 is defined to issue a new request to the storage device 2 after waiting for a reply from the storage device 2.

In the SATA standard, timing when the storage device 2 transmits the control signal (OOB signal, FIS signal, and the like) is not defined. Accordingly, timing capable of properly receiving the control signal from the storage device may be various in every host device 3. Even when each host device 3 receives the control signal from the storage device 2 at unexpected timing, there is a fear of failing in recognizing the signal correctly. As the result, disagreement happens in the data handled by the host device 3 and the storage device 2, which may disturb the normal operation of the host device 3 or the storage device 2.

On the contrary, as mentioned above, the storage device 2 according to the embodiments is designed to transmit the first control signal to the host device 3, after elapse of a predetermined time from the timing capable of transmitting the control signal for performing the coupling processing with the host device 3 in the coupling sequence. According to this, the storage device 2 can transmit the first control signal at the timing when the host device 3 can properly receive the first control signal. Accordingly, the storage device 2 can be recognized properly by the host device 3. The storage device 2 according to the embodiments can perform the coupling processing normally.

Further, as mentioned above, when the accuracy of the second control signal received from the host device 3 is determined favorable, the storage device 2 according to the embodiments is designed to transmit the first control signal to the host device 3 after elapse of the predetermined time. According to this, the storage device 2 can perform the processing corresponding to the correct control signal. Therefore, the storage device 2 can be properly recognized by the host device 3. The storage device 2 according to the embodiments can perform the coupling processing normally.

### First Embodiment

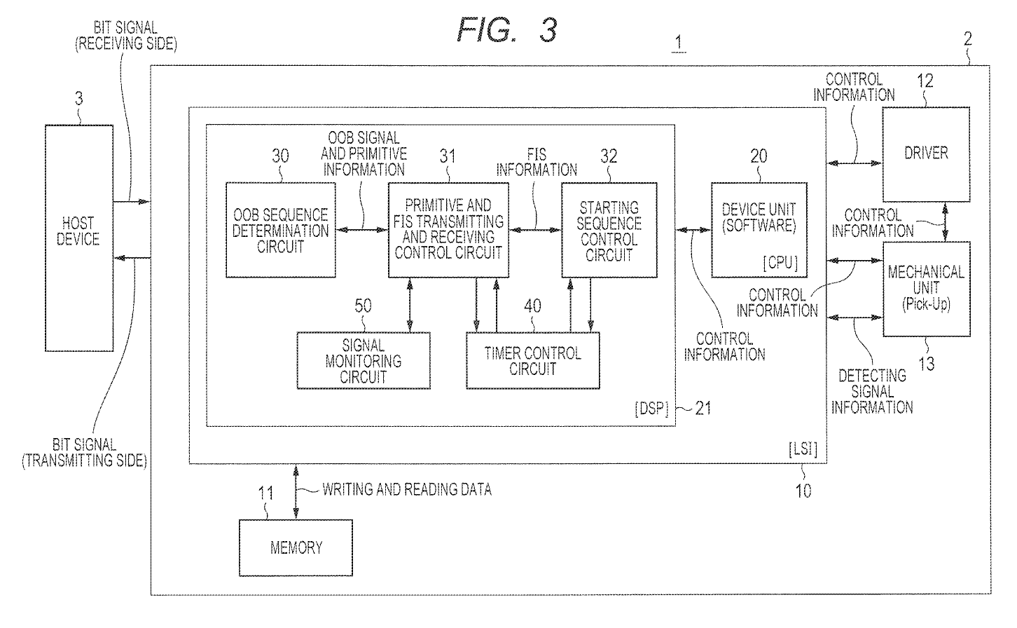

Next, a first embodiment will be described. FIG. 3 is a block diagram of a storage system 1 according to the first embodiment. The storage system 1 includes a storage device 2 and a host device 3. The storage device 2 includes Large Scale Integration (LSI) 10, a memory 11, a driver 12, and a mechanical unit 13. The LSI 10 includes a CPU 20 and a Digital Signal Processor (DSP) 21. The DSP 21 includes an OOB sequence determination circuit 30, a primitive and FIS transmitting and receiving control circuit 31, a starting sequence control circuit 32, a timer control circuit 40, and a signal monitor circuit 50. The embodiment is described in the case where the storage device 2 is an optical disk drive. The storage device 2, however, is not restricted to the optical disk drive.

The LSI 10 includes ATA Task Register (not illustrated) used for a control in the SATA standard, a function of the processing for a signal obtained from a disk, and a function for memory control. The memory 11 stores a program executed by the CPU 20, data calculated by the CPU 20, and data obtained from the disk.

The driver 12 controls the mechanical unit 13, based on the control information output from the CPU 20. The driver 12 controls the mechanical unit 13 by outputting the control information indicating the control contents of the mechanical unit 13 to the mechanical unit 13. The driver 12 controls, for example, the position of a lens for the optical disk (not illustrated). The mechanical unit 13 writes and reads data into and from the optical disk, based on the control information output from the CPU 20 and the driver 12.

The CPU 20 transmits and receives data to and from the host device 3, and controls the optical disk. The CPU 20 performs the above by executing a program for transmitting and receiving data to and from the host device 3 and a program for controlling the optical disk. For example, when receiving the FIS indicating the ATA/ATAPI command from the host device 3, the CPU 20 generates FIS responding to the ATA/ATAPI command indicated by the FIS and transmits the same to the host device 3. Specifically, the CPU 20 outputs the control information of requesting the transmission of the generated FIS, together with the generated FIS, to the primitive and FIS transmitting and receiving control circuit 31, then to transmit the FIS from the primitive and FIS transmitting and receiving control circuit 31 to the host device 3.

Further, the CPU 20 controls the mechanical unit 13. The CPU 20 outputs the control information indicating the control contents of the mechanical unit 13, to the mechanical unit 13. The CPU 20 adjusts, for example, the intensity of light with which the mechanical unit 13 irradiates the optical disk and the inclination of a lens.

The DSP 21 performs the processing in the starting sequence of the storage device 2, the transmitting and receiving processing of data, and the like. The DSP 21 can perform the processing as a substitution for the CPU 20. The OOB sequence determination circuit 30, the primitive and FIS transmitting and receiving control circuit 31, and the starting sequence control circuit 32 correspond to the coupling processing unit 6 shown in FIG. 1.

The OOB sequence determination circuit 30 monitors the progress of the OOB sequence. The OOB sequence determination circuit 30 generates OOB signal and Align according to the progress of the OOB sequence and transmits the above to the host device 3. The OOB sequence determination circuit 30 outputs the OOB signal/primitive information of requesting the transmission of the generated OOB signal or Align, together with the generated OOB signal or Align, to the primitive and FIS transmitting and receiving control circuit 31. According to this, the primitive and FIS transmitting and receiving control circuit 31 transmits the OOB signal or Align to the host device 3.

The primitive and FIS transmitting and receiving control circuit 31 transmits and receives the data such as the OOB signal, the primitive, the FIS, and the like to and from the host device 3. The primitive and FIS transmitting and receiving control circuit 31 transmits the FIS to the host device 3, based on the control information output from the CPU 20. The primitive and FIS transmitting and receiving control circuit 31 transmits the OOB signal or Align to the host device 3, based on the OOB signal/primitive information output from the OOB sequence determination circuit 30. The primitive and FIS transmitting and receiving control circuit 31 transmits the FIS to the host device 3, based on the FIS information output from the starting sequence control circuit 32.

The starting sequence control circuit 32 monitors the progress of the starting sequence of the storage device 2. The starting sequence control circuit 32 performs a shift of the operation mode of the storage device 2, generation of FIS, and transmission of the generated FIS to the host device 3, according to the progress of the OOB sequence. The starting sequence control circuit 32 outputs the FIS information of requesting the transmission of the generated FIS, together with the generated FIS, to the primitive and FIS transmitting and receiving control circuit 31. According to this, the primitive and FIS transmitting and receiving control circuit 31 transmits the FIS to the host device 3.

In the interface standard of the serial ATA, when establishing a communication in the physical layer, the ATA Task Register information has to be transmitted from the storage device 2 to the host. The procedure of transmitting the information will be described. At first, a serial signal is entered into the primitive and FIS transmitting and receiving control circuit 31 from the host device 3. The primitive and FIS transmitting and receiving control circuit 31 converts the serial signal into primitive/FIS format through the 10b/8b conversion. Further, the primitive and FIS transmitting and receiving control circuit 31 notifies the CPU 20 of the converted information. Depending on the notified information, the CPU 20 performs the control in accordance with the ATA/ATAPI protocol on the primitive and FIS transmitting and receiving control circuit 31. The CPU 20 determines that the OOB sequence is completed (receiving Align from the host) in the SATA physical layer. When detecting the end of the OOB sequence as the result of the determination, the CPU 20 controls the primitive and FIS transmitting and receiving control circuit 31 to transmit the ATA Task Register information to the host device 3.

As mentioned above, the OOB sequence determination circuit 30 monitors the start/end of the OOB sequence. The starting sequence control circuit 32 controls the information related to the monitoring by the OOB sequence determination circuit 30 (monitoring information) as mentioned above. Further, the host device 3 determines whether or not it can be normally coupled to the storage device 2, based on the monitoring information. The host device 3 controls the operation (an instruction to the storage device 2 and the like) after the coupling to the storage device 2.

The timer control circuit 40 corresponds to the timing control unit 4 shown in FIG. 1. The timer control circuit 40 controls the execution time of the coupling sequence as described later. The timer control circuit 40 performs a control to transmit the COMINIT to the host device 3, after elapse of a predetermined waiting time (set time) from the timing when the storage device 2 can transmit the COMINIT. Further, the timer control circuit 40 controls the transmission of the COMWAKE (Align and Sync Primitive) to the host device 3, after elapse of a predetermined wait time (set time) from the timing when the storage device 2 can transmit the COMWAKE (Align and Sync Primitive). In other words, the timer control circuit 40 controls the timing of the start and end of the OOB sequence.

Further, the timer control circuit 40 performs a control to transmit the ATA Task Register information to the host device 3, after elapse of a predetermined wait time from the timing when the storage device 2 can transmit the ATA Task Register information. In other words, the timer control circuit 40 controls the transmission timing of the ATA Task Register information.

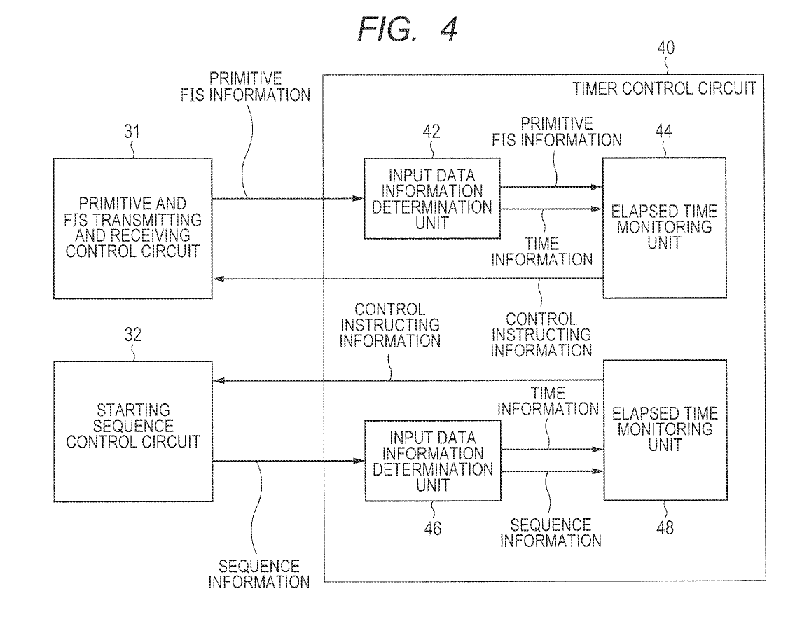

FIG. 4 is a view showing the structure of the timer control circuit 40 according to the first embodiment. The timer control circuit 40 includes an input data information determination unit 42, an elapsed time monitoring unit 44, an input data information determination unit 46, and an elapsed time monitoring unit 48. The input data information determination unit 42 and the elapsed time monitoring unit 44 control the transmission timing of the COMINIT and the COMWAKE in the OOB sequence. The input data information determination unit 46 and the elapsed time monitoring unit 48 control the transmission timing of the ATA Task Register information.

The input data information determination unit 42 receives the primitive and FIS information from the primitive and FIS transmitting and receiving control circuit 31. The input data information determination unit 42 outputs the time information indicating the time of receiving the primitive and FIS information, to the elapsed time monitoring unit 44. Further, the input data information determination unit 42 determines whether or not the received primitive and FIS information is proper, according to the SATA standard. When determining the information proper, the input data information determination unit 42 outputs the received primitive and FIS information to the elapsed time monitoring unit 44. While when determining the information improper, the input data information determination unit 42 outputs the primitive and FIS information conforming to the SATA standard to the elapsed time monitoring unit 44.

When the received primitive and FIS information is the proper information, indicating that COMRESET is transmitted from the host device 3, the elapsed time monitoring unit 44 monitors whether a predetermined set time T1 has elapsed from the time indicated in the time information output from the input data information determination unit 42. The set time T1 is a waiting time determined for every host device 3. The set time T1 corresponds to the period of the host device 3 starting from the transmission of the COMRESET until it is in a position of receiving the COMINIT. The elapsed time monitoring unit 44 transmits the control instructing information instructing to transmit the COMINIT to the host device 3, to the primitive and FIS transmitting and receiving control circuit 31, after elapse of the set time T1.

Further, when the received primitive and FIS information is the proper information and indicates that the COMWAKE is transmitted from the host device 3, the elapsed time monitoring unit 44 monitors whether a predetermined set time T2 has elapsed from the time indicated in the time information output from the input data information determination unit 42. The set time T2 is a waiting time determined for every host device 3. The set time T2 corresponds to the period of the host device 3 starting from the transmission of the COMWAKE until it is in a position of receiving the COMWAKE (“Device COMWAKE”) from a device side (storage device 2). After elapse of the set time T2, the elapsed time monitoring unit 44 transmits the control instructing information instructing to transmit the COMWAKE to the host device 3, to the primitive and FIS transmitting and receiving control circuit 31.

The input data information determination unit 46 receives the sequence information from the starting sequence control circuit 32. The input data information determination unit 46 outputs the time information indicating the receiving time of the sequence information to the elapsed time monitoring unit 48. The input data information determination unit 46 determines whether or not the received sequence information is proper, according to the SATA standard. When determining the information proper, the input data information determination unit 46 outputs the received sequence information to the elapsed time monitoring unit 48. While when determining the information improper, the input data information determination unit 46 outputs the sequence information conforming to the SATA standard to the elapsed time monitoring unit 48.

When the received sequence information is the proper information and indicates that the storage device 2 becomes the timing possible to transmit the ATA Task Register information, the elapsed time monitoring unit 48 monitors whether a predetermined set time T3 has elapsed from the time indicated in the time information output from the input data information determination unit 46. The set time T3 is a waiting time determined for every host device 3. The set time T3 corresponds to the period of the host device 3 starting from the transmission of the Align and the reception of the SYNC Primitive from the device side (storage device 2) until it is in a position of receiving the ATA Task Register information. After elapse of the set time T3, the elapsed time monitoring unit 48 transmits the control instructing information instructing to transmit the ATA Task Register information to the host device 3, to the starting sequence control circuit 32.

The set times T1 to T3 are set for every host device 3 to which the storage device 2 can be coupled. Accordingly, the set times T1 to T3 can be switched depending on the host device 3 to which the storage device 2 is coupled. For example, the set time T1 when the storage device 2 is coupled to the host A can be different from the set time T1 when it is coupled to the host B. The storage device 2 according to the embodiment can be coupled to any host device 3 normally.

The timer control circuit 40 as shown in FIG. 4 includes the two input data information determination units 42 and 46 and the two elapsed time monitoring units 44 and 48; however, the above circuit is not restricted to this structure. Only one set of the input data information determination unit and the elapsed time monitoring unit will do. In this case, one elapsed time monitoring unit stores various set times T1 to T3. As shown in FIG. 4, the processing becomes simpler in the case of separating the components for performing the timer control in the transmission timing of the COMINIT and COMWAKE and the transmission timing of the ATA Task Register information in the OOB sequence.

The signal monitoring circuit 50 corresponds to the signal determination unit 5 shown in FIG. 1. The signal monitoring circuit 50 determines the accuracy of the signal of the primitive information received from the host device 3. For example, when receiving the primitive information from the host device 3 out of the standard, wobbling of signal may occur. This signal wobbling phenomenon is referred to chattering. When the chattering occurs in signal, the accuracy of the signal is degraded, hence to disturb the correct detection of the signal. Specifically, when the chattering occurs in signal, 0 and 1 of the signal cannot be determined correctly. As the result, disagreement occurs in the data handled by the host device 3 and the storage device 2, and the host device 3 or the storage device 2 cannot operate normally.

The signal monitoring circuit 50 determines the chattering of signal. The signal monitoring circuit 50 controls the primitive and FIS transmitting and receiving control circuit 31 so that the storage device 2 does not transmit the ATA Task Register information, during the period of the chattering occurring in the signal, after the end of the OOB sequence. In other words, the signal monitoring circuit 50 controls the transmission timing of the ATA Task Register information.

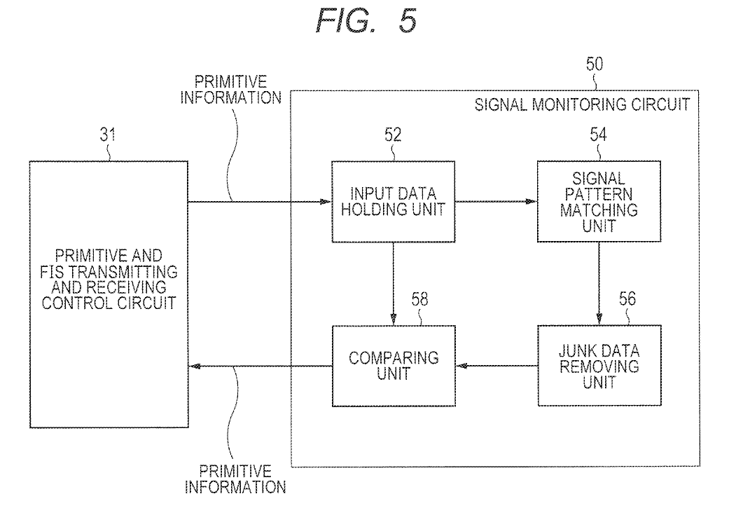

FIG. 5 is a view showing the structure of the signal monitoring circuit 50 according to the first embodiment. The signal monitoring circuit 50 includes an input data holding unit 52, a signal pattern matching unit 54, a junk data removing unit 56, and a comparing unit 58. The input data holding unit 52 receives the primitive information from the primitive and FIS transmitting and receiving control circuit 31 and holds the received primitive information.

The signal pattern matching unit 54 performs the pattern matching between the signal pattern related to the received primitive information and the previously stored signal pattern, to determine which signal it is. Further, the signal pattern matching unit 54 performs the pattern matching with the previously stored signal pattern, hence to determine the authentication of the signal (in or out of accordance with the standard). According to this, the signal pattern matching unit 54 determines the signal with more accuracy.

The junk data removing unit 56 removes the junk data transmitted in order to stabilize the signal state. The comparing unit 58 compares the previous input data with the current input data. When the accuracy is not favorable as the result of the determination by the signal pattern matching unit 54, the comparing unit 58 transmits the previous primitive information to the primitive and FIS transmitting and receiving control circuit 31. While, when the accuracy is favorable, as the result of the determination by the signal pattern matching unit 54, the comparing unit 58 transmits the current primitive information, or the primitive information of favorable accuracy to the primitive and FIS transmitting and receiving control circuit 31.

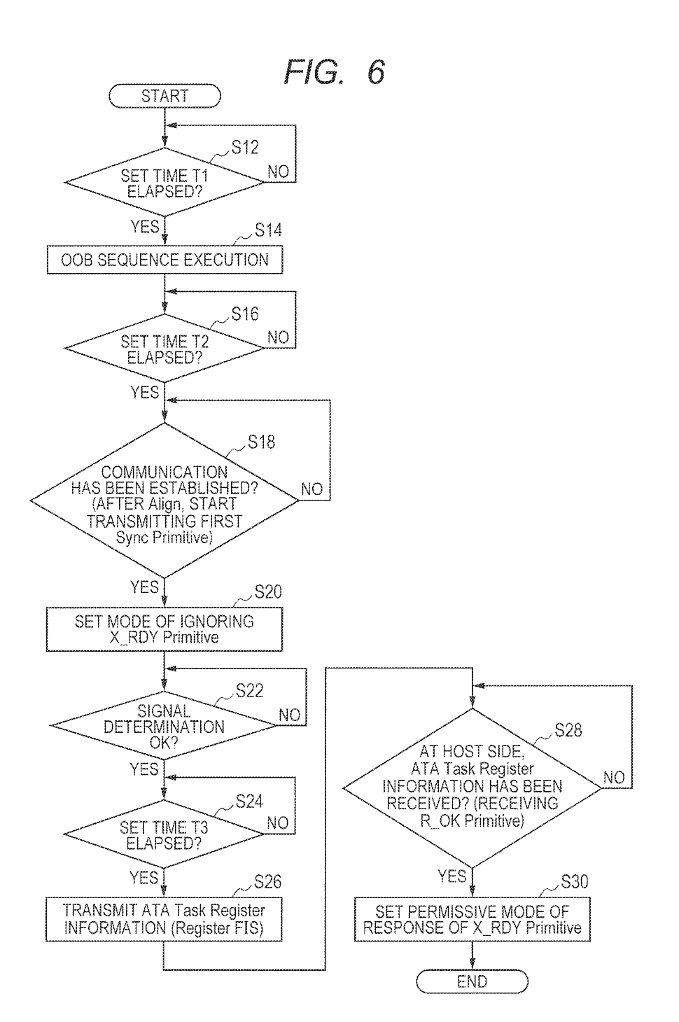

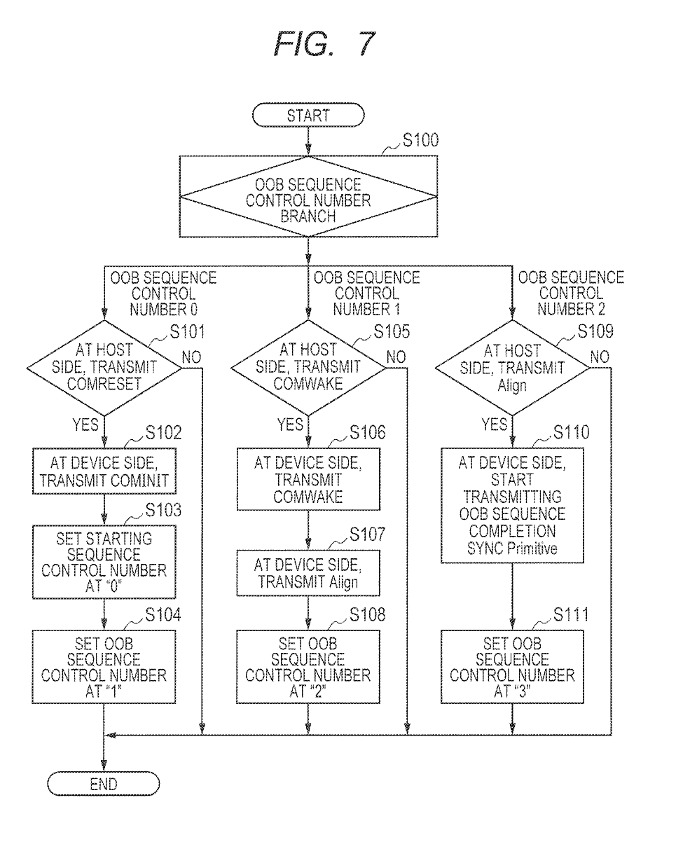

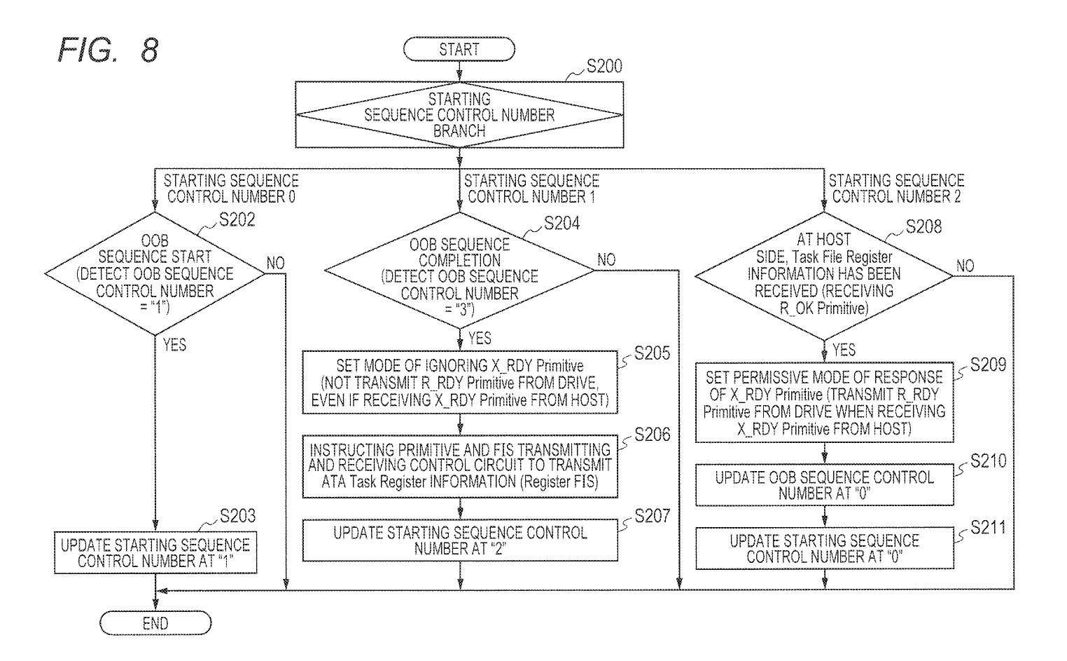

The processing of the storage system 1 according to the first embodiment will be described with reference to FIGS. 6 to 8. FIG. 6 is a flow chart showing the processing in the starting sequence of the storage device 2 according to the first embodiment. FIG. 7 is a flowchart showing the processing of the OOB sequence determination circuit 30 according to the first embodiment. FIG. 8 is a flow chart showing the processing of the starting sequence control circuit 32 according to the first embodiment.

When the storage device 2 and the host device 3 are mutually coupled to each other and activated, they start the OOB sequence (Step S14), after elapse of a specified time (YES in Step S12), to establish the SATA communication. The storage device 2 determines whether or not the specified time has elapsed after the host device 3 is in a possible state of finishing the OOS sequence (Step S16).

Specifically, the OOB sequence determination circuit 30 determines which value the OOB sequence control number is (Step S100). Here, the case where the initial value of the OOB sequence control number is “0” will be described. The OOB sequence control number is stored, for example, in a recording device included in the OOB sequence determination circuit 30. The recording device is, for example, a memory, a register, or the like. The OOB sequence control number is initialized at the initial value by the OOB sequence determination circuit 30, for example, at an activation time of the storage device 2.

When the OOB sequence control number is “0”, the OOB sequence determination circuit 30 determines whether or not the OOB sequence starts. Specifically, the OOB sequence determination circuit 30 determines whether or not the host device 3 transmits COMRESET (Step S101). When the host device 3 does not transmit the COMRESET (NO in S101), the OOB sequence determination circuit 30 continuously determines whether or not the host device 3 transmits the COMRESET (S101).

On the other hand, when the host device 3 transmits the COMRESET (YES in S101), the timer control circuit 40 determines whether or not the set time T1 has elapsed (S12). When the set time T1 has not elapsed (NO in S12), the timer control circuit 40 performs a control not to transmit the COMINIT but to be in a wait. On the other hand, when the set time T1 has elapsed (YES in S12), the timer control circuit 40 performs a control to transmit the COMINIT.

According to this, the OOB sequence determination circuit 30 transmits the COMINIT to the host device 3 (Step S102). Specifically, the OOB sequence determination circuit 30 outputs the OOB signal and primitive information requesting to transmit the COMINIT, to the primitive and FIS transmitting and receiving control circuit 31. The primitive and FIS transmitting and receiving control circuit 31 transmits the COMINIT to the host device 3, according to the OOB signal and primitive information from the OOB sequence determination circuit 30. The OOB sequence determination circuit 30 sets the starting sequence control number at “0” (Step S103). The OOB sequence determination circuit 30 updates the OOB sequence control number to “1” (Step S104). The OOB sequence determination circuit 30 outputs the updated starting sequence control number and OOB sequence control number to the starting sequence control circuit 32.

The starting sequence control circuit 32 determines which value the starting sequence control number is (Step S200). Here, the case where the initial value of the starting sequence control number is “0” will be described. The starting sequence control number is stored, for example, in the recording device included in the starting sequence control number. The starting sequence control number is initialized at the initial value by the starting sequence control circuit 32, for example, at an activation time of the storage device 2, or when the communication with the host is interrupted after once established.

When the starting sequence control number is “0”, the starting sequence control circuit 32 determines whether or not the OOB sequence starts (Step S202). Specifically, the circuit 32 determines whether or not the OOB sequence control number becomes “1”. When the OOB sequence control number is not “1” (NO in S202), the starting sequence control circuit 32 continuously determines whether or not the OOB sequence starts (S202).

On the other hand, when the OOB sequence control number becomes “1” (YES in S202), the starting sequence control circuit 32 recognizes that this operation is the determination processing for communication establishment and updates the starting sequence control number to “1” (Step S203). When the OOB sequence determination circuit 30 outputs the OOB sequence control number updated to “1”, the starting sequence control circuit 32 determines that the OOB sequence control number becomes “1”.

After the execution of S104, the OOB sequence determination circuit 30 determines the OOB sequence control number again (S100). When the OOB sequence control number is “1”, the OOB sequence determination circuit 30 determines whether or not the host device 3 transmits the COMWAKE (Step S105). When the host device 3 does not transmit the COMWAKE (NO in S105), the OOB sequence determination circuit 30 continuously determines whether or not the host device 3 transmits the COMWAKE (S105).

While when the host device 3 transmits the COMWAKE (YES in S105), the timer control circuit 40 determines whether or not the set time T2 has elapsed (S16). When the set time T2 has not elapsed (NO in S16), the timer control circuit 40 performs a control not to transmit the COMWAKE but to be in wait. On the other hand, when the set time T2 has elapsed (YES in S16), the timer control circuit 40 performs a control to transmit the COMWAKE.

According to this, the OOB sequence determination circuit 30 transmits the COMWAKE to the host device 3 (Step S106). Specifically, the OOB sequence determination circuit 30 outputs the OOB signal and primitive information requesting to transmit the COMWAKE to the primitive and FIS transmitting and receiving control circuit 31. The primitive and FIS transmitting and receiving control circuit 31 transmits the COMWAKE to the host device 3, according to the OOB signal and primitive information from the OOB sequence determination circuit 30.

The OOB sequence determination circuit 30 transmits Align to the host device 3 (Step S107). Specifically, the OOB sequence determination circuit 30 outputs the OOB signal and primitive information requesting to transit the Align to the primitive and FIS transmitting and receiving control circuit 31. The primitive and FIS transmitting and receiving control circuit 31 transmits the Align to the host device 3, according to the OOB signal and primitive information from the OOB sequence determination circuit 30. The OOB sequence determination circuit 30 updates the OOB sequence control number to “2” (Step S108). The OOB sequence determination circuit 30 outputs the updated OOB sequence control number to the starting sequence control circuit 32.

The OOB sequence determination circuit 30 determines the OOB sequence control number again (S100). When the OOB sequence control number is “2”, the OOB sequence determination circuit 30 determines whether or not the host device 3 transmits the Align (Step S109). When the host device 3 does not transmit the Align (NO in S109), the OOB sequence determination circuit 30 continuously determines whether or not the host device 3 transmits the Align (S109).

When the host device 3 transmits the Align (YES in S109), the OOB sequence is to be completed. In this case, the OOB sequence determination circuit 30 starts transmitting SYNC Primitive to the host device 3 (YES in Step S18 and Step S110). Specifically, the OOB sequence determination circuit 30 outputs the OOB signal and primitive information requesting to start the transmission of the SYNC Primitive to the primitive and FIS transmitting and receiving control circuit 31. The primitive and FIS transmitting and receiving control circuit 31 starts the transmission of the SYNC Primitive to the host device 3, according to the OOB signal and primitive information from the OOB sequence determination circuit 30. The OOB sequence determination circuit 30 updates the OOB sequence control number to “3” (Step S111). The OOB sequence determination circuit 30 outputs the updated OOB sequence control number to the starting sequence control circuit 32.

The starting sequence control circuit 32 determines the starting sequence control number again (S200) after the execution of the processing in S203. When the starting sequence control number is “1”, the starting sequence control circuit 32 determines whether or not the OOB sequence is completed (Step S204). Specifically, the starting sequence control circuit 32 determines whether or not the OOB sequence control number is “3”. When the OOB sequence control number is not “3”, the starting sequence control circuit 32 continuously determines whether or not the OOB sequence is completed (S204).

When the OOB sequence control number is “3” (YES in S204), the starting sequence control circuit 32 sets the operation mode of the storage device 2 at a mode of ignoring X_RDY Primitive (Step S20 and Step S205). Specifically, when the OOB sequence determination circuit 30 outputs the OOB sequence control number updated to “3”, the starting sequence control circuit 32 determines that the OOB sequence control number becomes “3”. According to this, the starting sequence control circuit 32 determines the OOB sequence is completed. All the requests from the host device 3 are rejected until the necessary response from the storage device 2 is completed after the completion of the OOB sequence; therefore, even when the X_RDY Primitive is transmitted from the host device 3, the mode is moved to a mode of not transmitting R_RDY Primitive from the storage device 2.

At this timing, the signal monitoring circuit 50 determines the signal (Step S22). Specifically, the signal monitoring circuit 50 determines whether or not the chattering (wobbling) occurs in the signal. In other words, the signal monitoring circuit 50 determines whether or not the accuracy of the signal is favorable. When it determines that the chattering occurs in the signal (NO in S22), the signal monitoring circuit 50 waits for the processing. When the number of determination of chattering or the time for determination of the chattering exceeds a predetermined value, reset of the coupling processing (transmission of COMINIT) may be performed.

When it determines that no chattering occurs in the signal (YES in S22), the timer control circuit 40 determines whether or not the set time T3 has elapsed (Step S24). When the set time T3 has not elapsed (NO in S24), the timer control circuit 40 performs a control not to transmit ATA Task Register information (Register FIS) but to be in wait. On the other hand, when the set time T3 has elapsed (YES in S24), the timer control circuit 40 performs a control to transmit the ATA Task Register information (Register FIS).

According to this, the starting sequence control circuit 32 transmits the FIS including the ATA Task Register information (hereinafter, also referred to “Register FIS”) to the host device 3 (Step S26 and Step S206). Specifically, the starting sequence control circuit 32 outputs the FIS information requesting to transmit the Register FIS to the primitive and FIS transmitting and receiving control circuit 31. The primitive and FIS transmitting and receiving control circuit 31 transmits the Register FIS to the host device 3, according to the FIS information from the starting sequence control circuit 32. The starting sequence control circuit 32 updates the starting sequence control number to “2” (Step S207).

The starting sequence control circuit 32 determines the starting sequence control number again (S200). When the starting sequence control number is “2”, the starting sequence control circuit 32 determines whether or not the Register FIS has been transmitted correctly (Step S28 and Step S208). Specifically, the starting sequence control circuit 32 determines whether or not the primitive and FIS transmitting and receiving control circuit 31 has received the R_OK Primitive transmitted from the host device 3 at the completion of receiving the Register FIS.

When the above circuit 31 has not received the R_OK Primitive (NO in S28 and NO in S208), the starting sequence control circuit 32 continuously determines whether or not the Register FIS has been correctly transmitted (S208). On the other hand, when it has received the R_OK Primitive (YES in S28 and YES in S208), the starting sequence control circuit 32 sets the operation mode of the storage device 2 at a permissive mode of a response of the X_RDY Primitive (Step S30 and Step S209). Specifically, when the host device 3 transmits the X_RDY Primitive, to enable a request from the host device 3, the mode is moved to a mode of transmitting the R_RDY Primitive from the storage device 2.

The starting sequence control circuit 32 updates the OOB sequence control number to “0” (Step S210). The starting sequence control circuit 32 updates the starting sequence control number to “0” (Step S211). The OOB sequence control number is initialized by, for example, the starting sequence control circuit 32 outputting initialization requesting information requesting the initialization of the OOB sequence control number to the OOB sequence determination circuit 30 and the OOB sequence determination circuit 30 responding to the initialization requesting information.

According to this, the storage device 2 is ready to establish the next SATA communication. As the case of establishing a communication again from the processing in Step S12, there are, for example, the case of re-coupling the storage device 2 and the host device 3 to each other, the case where the host device 3 detects a wrong operation of the storage device 2 and resets the storage device 2 according to the COMRESET, and the like. The host device 3 resets the storage device 2, for example, when there is no response from the storage device 2 for a predetermined time period.

Then, the starting sequence control circuit 32 outputs end notification information of notifying that the SATA communication establishing processing and the ATA Task Register information (Register FIS) have been transmitted, to the CPU 20. According to the end notification information output from the starting sequence control circuit 32, the CPU 20 starts the processing of transmitting and receiving data to and from the host device 3. The CPU 20 transmits instruction information of instructing the DSP 21 to execute the above mentioned processing in the starting sequence, to the DSP21, when executing the starting sequence of the storage device 2 again after receiving the end notification information. The DSP 21 executes the above mentioned starting sequence, according to the instruction information output from the CPU 20.

The storage device 2 according to the first embodiment is designed to transmit the control signal (COMINIT, COMWAKE, and ATA Task Register information) to the host device 3, after elapse of a predetermined set time from the timing possible to transmit the control signal for performing the coupling processing with the host device 3 in the coupling sequence. According to this, the storage device 2 can transmit the control signal at the timing when the host device 3 can properly receive the control signal. Therefore, the host device 3 can recognize the storage device 2 properly. As the result, the storage device 2 according to the embodiment can perform the coupling processing normally.

The storage device 2 according to the embodiment is designed to transmit the control signal (ATA Task Register information) to the host device 3, after elapse of a set time when it is determined that the accuracy of the control signal received from the host device 3 is favorable. According to this, the storage device 2 can perform the processing corresponding to the correct control signal. Therefore, the host device 3 can recognize the storage device 2 properly. The storage device 2 according to the embodiment can perform the coupling processing normally.

The storage device 2 according to the first embodiment is designed in that the timer control circuit 40 controls the transmission timing of the COMINIT, COMWAKE, and ATA Task Register information. According to this, the storage device 2 according to the first embodiment can transmit the COMINIT, the COMWAKE, and the ATA Task Register information respectively at the respective timings when the host device 3 can properly receive the COMINIT, the COMWAKE, and the ATA Task Register information, even in the case of using the SATA standard. Therefore, the host device 3 can recognize the storage device 2 properly. As the result, the storage device 2 according to the first embodiment can perform the coupling processing normally, even in the case of using the SATA standard.

The timer control circuit 40 according to the first embodiment is formed by the hardware circuit in the LSI 10. Therefore, the storage device 2 according to the first embodiment can set the time more minutely, compared with the case of controlling the transmission timing of the control information by software. As the result, the number of the host devices 3 capable of getting a normal coupling can be increased.

### Second Embodiment

Next, a second embodiment will be described. A storage device 2 according to the second embodiment is different from the storage device 2 according to the first embodiment in that the processing is performed to cope with the case of losing the physically coupling state indicating that a physically coupling with the device 3 is established.

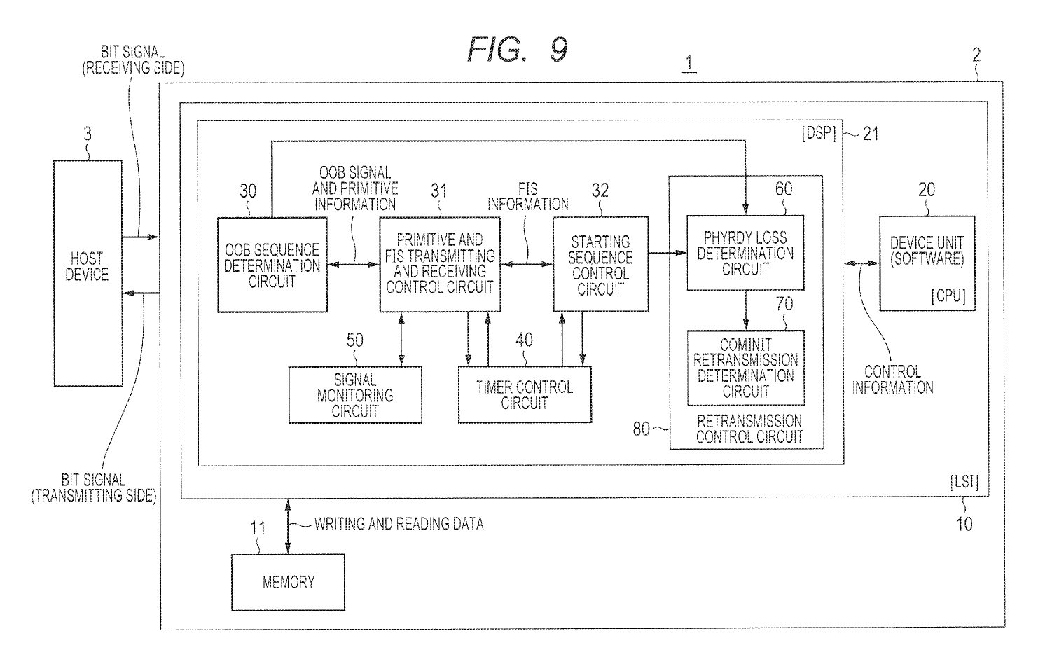

FIG. 9 is a block diagram of a storage system 1 according to the second embodiment. The storage system 1 according to the second embodiment includes the storage device 2 and the host device 3. In FIG. 9, the driver 12 and the mechanical unit 13 are not illustrated.

The DSP 21 of the storage device 2 includes an OOB sequence determination circuit 30, a primitive and FIS transmitting and receiving control circuit 31, a starting sequence control circuit 32, a timer control circuit 40, and a signal monitoring circuit 50. The DSP 21 according to the second embodiment further includes a PHYRDY loss determination circuit 60 (communication state determination unit), a COMINIT retransmission determination circuit 70 (retransmission control unit). The components other than the PHYRDY loss determination circuit 60 and the COMINIT retransmission determination circuit 70 are substantially the same as those according to the first embodiment; therefore, their description is omitted. The PHYRDY loss determination circuit 60 and the COMINIT retransmission determination circuit 70 form a retransmission control circuit 80 (retransmission control unit). The retransmission control circuit 80 controls the retransmission of the COMINIT.

The PHYRDY loss determination circuit 60 monitors the state of PHYRDY. The “PHYRDY” is a signal indicating that the physical communication is established. After the completion of the OOB sequence (transmission of Align from the host device 3), data can be transmitted and received in a physically-communication established state with the PHYRDY transmitted. On the other hand, when the PHYRDY is lost, or a physically coupling state is lost, because of a failure happening in the communication between the host device 3 and the storage device 2, the data communication is in a shut-off state. The PHYRDY loss determination circuit 60 determines a physical communication state by determining whether or not the PHYRDY is lost. The PHYRDY loss determination circuit 60 outputs the determination result to the COMINIT retransmission determination circuit 70.

The COMINIT retransmission determination circuit 70 determines whether or not to retransmit the COMINIT according to the condition specified by the CPU 20. When the situation agrees with the condition, the COMINIT retransmission determination circuit 70 performs a control to retransmit the COMINIT. In other words, when the physical communication state is lost, the retransmission control circuit 80 performs the control to retransmit the COMINIT, according to a predetermined condition. Even when determining that the PHYRDY is lost, the retransmission control circuit 80 performs a control not to transmit the COMINIT as a request of recoupling immediately. According to this, the host device 3 at the opposite party executes the recoupling processing.

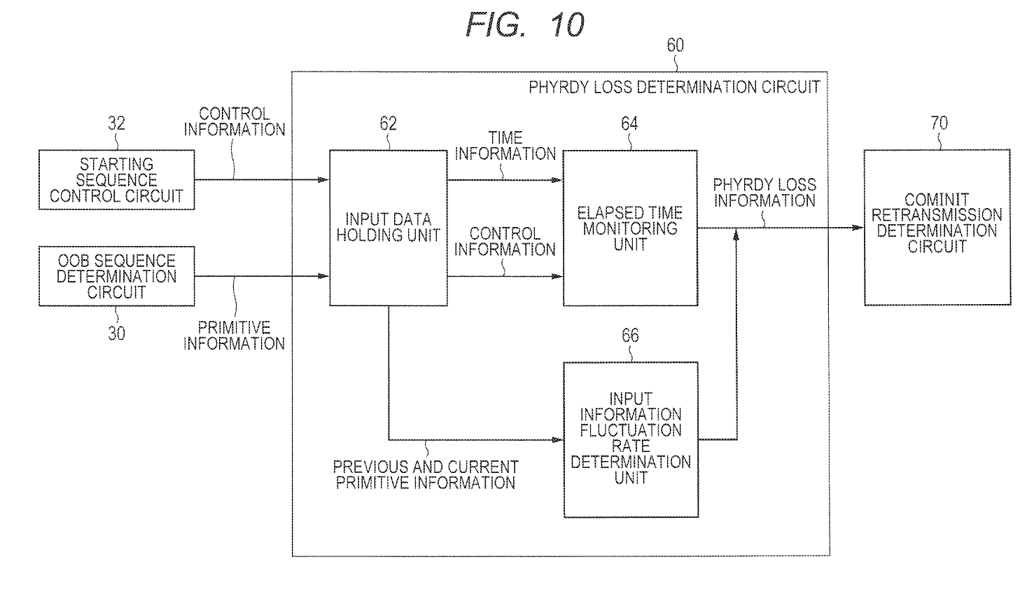

FIG. 10 is a view showing the structure of the PHYRDY loss determination circuit 60 according to the second embodiment. The PHYRDY loss determination circuit 60 includes an input data holding unit 62, an elapsed time monitoring unit 64, and an input information fluctuation rate determination unit 66.

The input data holding unit 62 receives the control information from the starting sequence control circuit 32. The input data holding unit 62 further receives the primitive information from the OOB sequence determination circuit 30. The input data holding unit 62 holds the primitive information. Further, the input data holding unit 62 determines the current operational state according to the control information. Specifically, the input data holding unit 62 determines whether or not the PHYRDY is lost, according to the input data. When the PHYRDY is lost, or when the data can not be received, the input data holding unit 62 determines whether or not the storage device 2 is under activation or execution, according to the control information.

When the storage device 2 is under activation, the input data holding unit 62 outputs the time information and the control information to the elapsed time monitoring unit 64. Here, the time information indicates the time when the input data holding unit 62 receives the control information. On the other hand, when the storage device 2 is under execution, the input data holding unit 62 outputs the previous primitive information and the current primitive information to the input information fluctuation rate determination unit 66.

The elapsed time monitoring unit 64 performs the processing when the storage device 2 is under activation. The elapsed time monitoring unit 64 monitors whether a predetermined set time T4 has elapsed since the time indicated in the time information output from the input data holding unit 62. The set time T4 is the time indicating how much to wait until a signal gets stabilized. After elapse of the set time T4, the elapsed time monitoring unit 64 transmits the PHYRDY lost information indicating the loss of the PHYRDY to the COMINIT retransmission determination circuit 70. In short, the elapsed time monitoring unit 64 waits without transmitting the PHYRDY loss information to the COMINIT retransmission determination circuit 70, until the set time T4 elapses.

The input information fluctuation rate determination unit 66 performs the processing when the storage device 2 is under execution. The input information fluctuation rate determination unit 66 determines whether or not a fluctuation rate between the previous primitive information and the current primitive information is a predetermined threshold Thi and more. Alternatively, with a signal pattern of a higher fluctuation rate stored there, the input information fluctuation rate determination unit 66 may determine the fluctuation rate by comparison with the signal pattern. When the fluctuation rate between the previous primitive information and the current primitive information is the threshold Thi and more, the input information fluctuation rate determination unit 66 waits without transmitting the PHYRDY loss information to the COMINIT retransmission determination circuit 70. When the fluctuation rate between the previous primitive information and the current primitive information is less than the threshold Thi, the input information fluctuation rate determination unit 66 transmits the PHYRDY loss information to the COMINIT retransmission determination circuit 70.

Therefore, the COMINIT retransmission determination circuit 70 receives the PHYRDY loss information when the signal may be stabilized in the storage device 2, during the activation or the execution of the storage device 2. The COMINIT retransmission determination circuit 70 determines whether or not to retransmit the COMINIT, according to a predetermined condition. For example, when a condition of using a function of retransmitting the COMINIT is set, the COMINIT retransmission determination circuit 70 retransmits the COMINIT. On the other hand, when a condition of not using this function is set, the COMINIT retransmission determination circuit 70 does not retransmit the COMINIT.

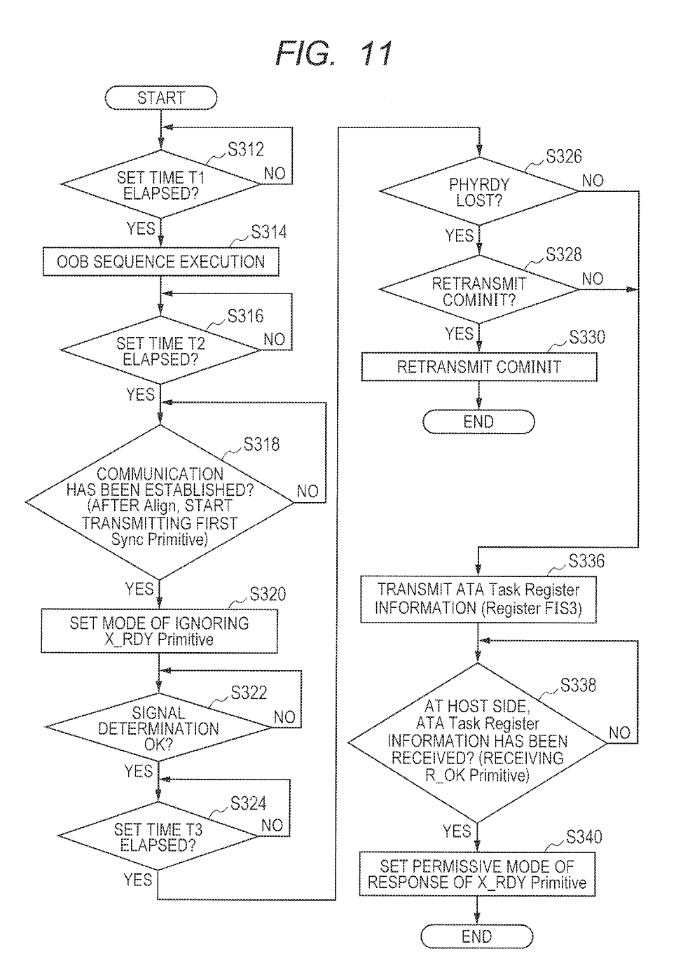

Next, the processing of a storage system 1 according to the second embodiment will be described with reference to FIG. 11. FIG. 11 is a flow chart showing the processing in the starting sequence of the storage device 2 according to the second embodiment. FIG. 11 shows a flow of performing the PHYRDY loss determination according to the second embodiment at the activation time of the storage device 2. As described using FIG. 10, however, the PHYRDY loss determination according to the second embodiment can be performed also during the execution after the activation of the storage device 2.

Since the processing in Steps S312 to S324 respectively corresponds to the processing in S12 to S24 shown in FIG. 6, the description is omitted. Further, since the processing in Steps S336 to S340 respectively corresponds to the processing in S26 to S30 shown in FIG. 6, the description is omitted.

When the set time T3 elapsed (YES in S324), the PHYRDY loss determination circuit 60 determines whether or not to transmit the PHYRDY loss information (Step S326). Specifically, the PHYRDY loss determination circuit 60 determines whether or not the PHYRDY is lost. When determining that the PHYRDY is lost, the PHYRDY loss determination circuit 60 determines whether or not to transmit the PHYRDY loss information, as mentioned above.

When the PHYRDY loss information is not determined to be output (NO in S326), the processing proceeds to S336. On the other hand, when the PHYRDY loss information is determined to be output (YES in S326), the PHYRDY loss determination circuit 60 transmits the PHYRDY loss information to the COMINIT retransmission determination circuit 70. The COMINIT retransmission determination circuit 70 determines whether or not to retransmit the COMINIT, according to a predetermined condition (Step S328). When the COMINIT is determined to be retransmitted (YES in S328), the COMINIT retransmission determination circuit 70 performs a control to retransmit the COMINIT (Step S330). On the other hand, when the COMINIT is not determined to be retransmitted (NO in S328 [symbol] NO), the processing proceeds to S336.

The SATA standard is generally defined to immediately reset the coupling after the PHYRDY is lost and restart the OOB sequence to establish a physical communication of the SATA. Specifically, when detecting the loss of the PHYRDY, the storage device 2 immediately transmits the COMINIT to the host device 3, to request the establishment of communication.

Monitoring of the PHYRDY is performed by both the storage device 2 and the host device 3. Therefore, even when the PHYRDY is determined to be lost in the storage device 2, the host device 3 may determine that the PHYRDY is not lost. In this case, even when the COMINIT is transmitted to the host device 3, the recoupling processing may not be properly performed.

Concretely, when the state of the PHYRDY signal is not stabilized, like repetition of LOW (loss) and HIGH, even when the storage device 2 retransmits the COMINIT to start the OOB sequence immediately after the PHYRDY becomes LOW, the OOB sequence is to be repeated again and again because the communication establishment is lost again. Since a serial signal is generated in an analog circuit, it sometimes becomes unstable, depending on the parts of a substrate of the analog circuit. On the other hand, according to elapse of time, the signal may be stable. Therefore, a repetition of the OOB sequence again and again may be wasteful.

On the other hand, the retransmission control circuit 80 according to the second embodiment performs a control not to immediately transmit the COMINIT that is a recoupling request even in the case of losing the PHYRDY. According to this, when the signal gets stable, the host device 3 at the opposite side can perform the recoupling processing immediately. Therefore, the coupling processing of the OOB sequence can be performed for the least number of times (for example, once). As the result, the storage device 2 according to the second embodiment can be easily coupled to the host device 3 in the recoupling processing. The storage device 2 according to the second embodiment can suppress an increase in the time taken for the recoupling.

When the PHYRDY is lost, the retransmission control circuit 80 according to the second embodiment performs a control to retransmit the COMINIT when a signal from the host device 3 is determined stable. According to this, also the storage device 2 can perform the recoupling processing properly.

### Modified Example

The invention is not restricted to the above mentioned embodiments but various modifications can be properly made without departing from the spirit. For example, the sequence of the respective processing may be properly changed in the flow chart of the above mentioned embodiments.

In the above mentioned embodiments, although the case of using the SATA as the interface standard between the storage device 2 and the host device 3 has been described, the embodiments can be adopted to any interface standard other than the SATA standard. For example, the embodiments can be adopted also to Universal Serial Bus (USB) or Peripheral Component Interconnect (PCI).

Although the storage device 2 according to the embodiments includes the signal determination unit 5 (signal monitoring circuit 50), the invention is not restricted to this structure. In the embodiments, the signal determination unit 5 (signal monitoring circuit 50) is not necessarily the essential component. By including the signal determination unit 5 (signal monitoring circuit 50), however, the storage device 2 is designed to transmit a control signal to the host device 3 when the accuracy of the control signal received from the host device 3 is determined favorable. According to this, the storage device 2 can perform the processing corresponding to a correct control signal.

Further, the above mentioned program can be supplied to a computer being stored in various types of non-temporary computer readable medium. The non-temporary computer readable medium includes various types of substantial recording medium. The non-temporary computer readable medium includes magnetic recording medium (for example, flexible disk, magnetic tape, and hard disk drive), optical magnetic recording medium (for example, optical magnetic disk), CD-Read Only Memory (ROM), CD-R, CD-R/W, and a semiconductor memory (for example, a mask ROM, a Programmable ROM (PROM), and Erasable PROM (EPROM), a flash ROM, a Random Access Memory (RAM)). The program may be supplied to a computer by various types of temporary computer readable medium. The temporary computer readable medium includes electric signal, optical signal, and magnetic wave. The temporary computer readable medium can supply a program to a computer through a wired communication channel such as wiring and optical fiber, or wireless communication channel.

As set forth hereinabove, the invention made by the inventor et al. has been concretely described based on the embodiments; the invention is not restricted to the above mentioned embodiments but needless to say, various modifications are possible without departing from its spirit.

What is claimed is:

1. A storage device comprising:
a coupling processing unit that performs coupling processing with a host device according to a predetermined coupling sequence, and
a timing control unit that controls the coupling processing unit to transmit a first control signal for performing coupling processing with the host device, to the host device, after elapse of a predetermined set time from timing capable of transmitting the first control signal to the host device in the coupling sequence.

2. The device according to claim 1, further comprising
a signal determination unit that determines accuracy of a second control signal received from the host device,
wherein the timing control unit controls the coupling processing unit to transmit the first control signal to the host device, after elapse of the set time, when the signal determination unit determines that the accuracy of the second control signal is favorable.

3. The device according to claim 2, further comprising
a retransmission control unit that performs a control to retransmit the first control signal, according to a predetermined condition, when losing a physical communication established state indicating that a physical communication with the host device is established.

4. The device according to claim 3,
wherein the retransmission control unit performs a control to retransmit the first control signal when a signal from the host device is determined stable.

5. The device according to claim 1,
wherein the set time is set for every host device to which the storage device is connectable.

6. The device according to claim 1,
wherein the storage device transmits and receives data to and from the host device, according to Serial Advanced Technology Attachment (SATA) standard, and
wherein the timing control unit performs a control to transmit COMINIT to the host device, after elapse of the set time from timing when the storage device is in a position to transmit the COMINIT.

7. The device according to claim 1,
wherein the storage device transmits and receives data to and from the host device, according to the SATA standard, and
wherein the timing control unit performs a control to transmit COMWAKE to the host device, after elapse of the set time from timing when the storage device is in a position to transmit the COMWAKE.

8. The device according to claim 1,
wherein the storage device transmits and receives data to and from the host device, according to the SATA standard, and
wherein the timing control unit performs a control to transmit ATA Task Register information to the host device, after elapse of the set time from timing when the storage device is in a position to transmit the ATA Task Register information.

9. The device according to claim 1,
wherein the timing control unit is formed by a hardware circuit.

10. A storage system comprising:
a host device, and
a storage device coupled to the host device,
wherein the storage device includes
a coupling processing unit that performs coupling processing with the host device according to a predetermined coupling sequence, and
a timing control unit that controls the coupling processing unit to transmit a first control signal for performing coupling processing with the host device, to the host device, after elapse of a predetermined set time from timing capable of transmitting the first control signal to the host device in the coupling sequence.

11. The system according to claim 10,
wherein the storage device further includes
a signal determination unit that determines accuracy of a second control signal received from the host device,
wherein the timing control unit controls the coupling processing unit to transmit the first control signal to the host device, after elapse of the set time, when the signal determination unit determines the accuracy of the second control signal is favorable.

12. The system according to claim 11,
wherein the storage device further includes
a retransmission control unit that performs a control to retransmit the first control signal, according to a predetermined condition, when losing a physical communication established state indicating a physical communication with the host device.
